(19) United States
(12) Patent Application Publication
(10) Pub. No.: US 2026/0336308 A1
(43) Pub. Date: Oct. 29, 2026

(54) RECORDING APPARATUS INCLUDING READING UNIT

(71) Applicant: CANON KABUSHIKI KAISHA, Tokyo (JP)

(72) Inventors: TOSHIRO SUGIYAMA, Kanagawa (JP); MASAKI TAKESHIMA, Kanagawa (JP); HIROKI INOUE, Tokyo (JP); YASUYUKI ASAI, Tokyo (JP); TAKESHI KODA, Kanagawa (JP)

(21) Appl. No.: 19/653,445

(22) Filed: Apr. 21, 2026

(30) Foreign Application Priority Data
Apr. 28, 2025 (JP) 2025-074536

(51) Int. Cl. B41J 3/44; B41J 2/175; B41J 15/04; B41J 29/13; H04N 1/00; H04N 1/23

(52) U.S. Cl. CPC B41J 3/44; B41J 2/175; B41J 15/04; B41J 29/13; H04N 1/00543; H04N 1/00665; H04N 1/2323; H04N 2201/0094

(57) ABSTRACT

A recording apparatus includes: a holding portion configured to hold a rolled sheet; a recording portion configured to perform, above the holding portion, recording on a sheet supplied from the rolled sheet held by the holding portion; a housing configured to accommodate the recording portion; a cover configured to move between an open position at which the recording portion is exposed to an outside from a front side of the housing and a closed position at which the recording portion is closed relative to the open position; and a reading unit that performs reading of a document. A direction in which the cover moves from the closed position toward the open position is a first direction from the front side toward a rear side of the housing, and the reading unit is arranged further toward the rear side than the cover in the first direction.

### BACKGROUND

### Field of the Technology

The present disclosure relates to a recording apparatus including a reading unit.

### Description of the Related Art

As composite apparatuses capable of performing recording on large sheets as recording materials and reading of large documents, various composite apparatuses that allow users to access the apparatuses from the front side have been proposed (Japanese Patent Application Laid-open Nos. 2021-158403 and 2020-167593). Such composite apparatuses are configured such that sheets or documents are discharged from the front side, an operation panel serving as an operation portion is arranged to face the front side, a front cover is openable and closable as an access cover for accessing the inside of the apparatus during maintenance, and an ink tank is replaceable from the front side of the apparatus.

Particularly, in composite apparatuses for large sheets, a conveyance path for sheets or documents occupies, as viewed from the front side, most of the area in the width direction of the apparatus. Japanese Patent Application Laid-open No. 2021-158403 proposes a configuration in which ink tanks and an operation panel are arranged on a lateral side of an access cover so as to allow access to the ink tanks and the operation panel from the front side without interfering with opening and closing of the access cover (front cover), which covers a conveyance path for sheets or the like. With such a configuration, most operations on the apparatus can be performed from the front side, but there is a concern that the apparatus may become wider. Furthermore, Japanese Patent Application Laid-open No. 2020-167593 proposes a configuration in which a mechanism for displaceably supporting a reading portion and an operation panel is provided, thereby making it possible to displace the reading portion and the operation panel between a use position and a retracted position during their operation and opening and closing of an access cover. Although such a mechanism suppresses an increase in size in the width direction, there is a concern that operation of the apparatus may become complicated or that provision of a mechanism capable of displacing the reading portion, which is a relatively heavy object, may lead to an increase in cost.

### SUMMARY

An object of the present disclosure is to provide a technology capable of improving operability of an apparatus.

According to some embodiments, a recording apparatus of the present disclosure is characterized by features including: a holding portion configured to be capable of holding a rolled sheet in which a sheet is wound into a roll; a recording portion configured to perform, above the holding portion, recording on a sheet supplied from the rolled sheet held by the holding portion; a housing configured to accommodate the recording portion; a cover configured to be movable between an open position at which the recording portion is exposed to an outside from a front side of the housing and a closed position at which the recording portion is closed relative to the open position; and a reading unit configured to perform reading of a document, wherein a direction in which the cover moves from the closed position toward the open position is a first direction from the front side toward a rear side of the housing, and the reading unit is arranged further toward the rear side than the cover in the first direction.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views illustrating a composite apparatus according to a first embodiment.

FIG. 2 is a cross-sectional view of a recording unit.

FIG. 3 is a cross-sectional view of a reading unit.

FIG. 4 is a control block diagram of the composite apparatus.

FIGS. 5A and 5B are perspective views illustrating the composite apparatus according to the first embodiment.

FIGS. 6A and 6B are perspective views illustrating the composite apparatus according to the first embodiment.

FIGS. 7A-7C are top views illustrating the composite apparatus according to a second embodiment.

FIGS. 8A and 8B are side views illustrating the composite apparatus according to the second embodiment.

FIG. 9 is a perspective view illustrating a holding portion according to a third embodiment.

FIGS. 10A-10C are top views illustrating the composite apparatus according to the third embodiment.

FIG. 11 is a side view illustrating the composite apparatus according to the third embodiment.

FIG. 12 is a top view illustrating the composite apparatus according to the second embodiment.

### DESCRIPTION OF THE EMBODIMENTS

Hereinafter, with reference to the drawings, embodiments for carrying out the present disclosure will be exemplarily described in detail on the basis of examples. However, the dimensions, materials, shapes, relative arrangements, and the like of the components described in the embodiments may be appropriately modified depending on the configurations and various conditions of the apparatus to which the present disclosure is applied. That is, the scope of the present disclosure is not intended to be limited to the embodiments described below. Furthermore, although a plurality of characteristics are described in the embodiments, all of the characteristics are not necessarily essential to the present disclosure, and the characteristics may be combined with each other in any way. In addition, in the accompanying drawings, the same reference numerals denote the same or similar components, and redundant descriptions thereof are be omitted.

Hereinafter, a printer of an inkjet system will be described as an example of a recording apparatus. However, the printing system is not limited the inkjet system, and various other systems, including electrophotographic systems and thermal transfer systems, are also applicable. Inkjet systems may include various systems, such as systems using heating elements, systems using piezoelectric elements, systems using electrostatic elements, and systems using MEMS elements. Furthermore, the present disclosure is also applicable to composite apparatuses having a copying function and a scanning function, that is, so-called multifunction printers.

In the drawings, X and Y indicate two axial directions that are orthogonal to each other on a horizontal plane, and Z indicates a vertical direction. In addition, Y1 and Y2 indicate directions parallel to the Y-axis direction, where Y1 indicates a direction from a front side toward a rear side in a front-rear direction of the recording apparatus according to the present embodiment, and Y2 indicates a direction opposite to Y1 (i.e., a direction from the rear side to the front side of the recording apparatus). Furthermore, Z1 indicates a lower side in the vertical direction, and Z2 indicates an upper side in the vertical direction. Furthermore, in each drawing, the recording apparatus is illustrated as being installed on a horizontal plane in a normally assumed installation state.

In this specification, the term “recording” (which may also be referred to as “printing”) refers not only to forming meaningful information such as characters and graphics, but also to forming information regardless of whether it is meaningful. In addition, the term broadly encompasses forming images, designs, patterns, or the like on a recording medium, or processing a medium, regardless of whether the result is manifested in a form perceptible to the human eye.

Furthermore, the term “recording medium” (which may also be referred to as a “recording material”) refers not only to paper used in general recording apparatuses, but also broadly to materials capable of accommodating ink, such as fabrics, plastic films, metal plates, glass, ceramics, wood, and leather. Note that in the following embodiments, a case will be described in which the recording medium is a rolled sheet (or simply referred to as a “sheet”) in which a sheet is wound into a roll, but the present disclosure is not limited thereto.

### First Embodiment

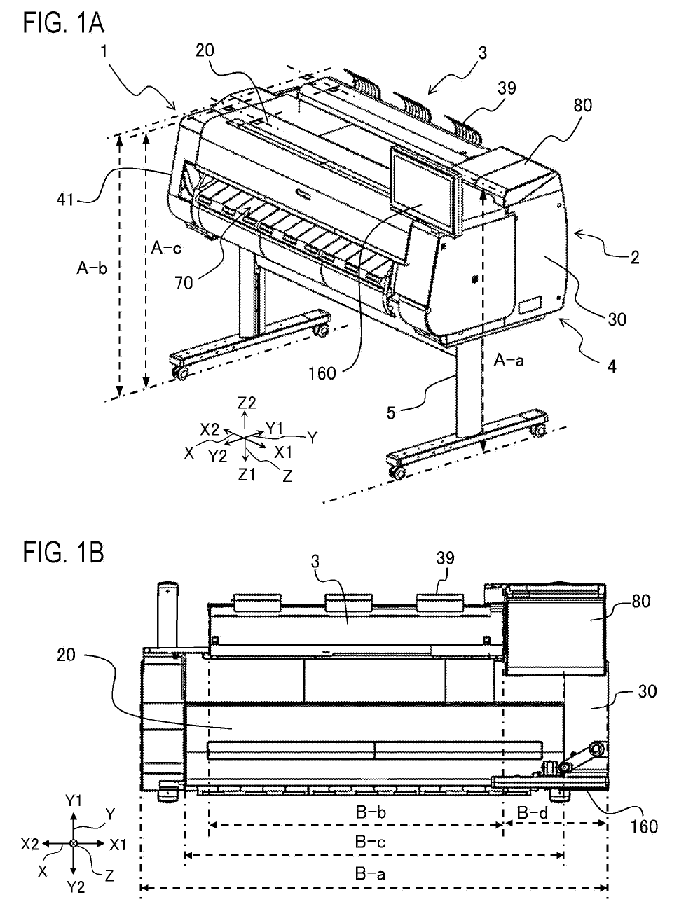

FIG. 1A is a perspective view illustrating a composite apparatus (recording system) 1 serving as a recording apparatus according to a first embodiment. FIG. 1B is a view (plan view) of the composite apparatus 1 of this embodiment as viewed from above.

As illustrated in FIGS. 1A and 1B, the composite apparatus 1 includes a recording unit 2 including a recording portion, a reading unit 3 including a reading portion, an access cover 20, an ink tank unit 30 serving as a liquid supply unit, and an operation display portion (operation portion) 160 serving as a large operation panel. The recording unit 2 is configured to perform printing on a sheet serving as a recording medium. The reading unit 3 (document reading apparatus) is configured to read an image or the like formed on a document. The reading unit 3 is arranged further toward the rear side than the recording unit 2. The arrangement of the components will be described in detail later.

As illustrated in FIG. 1A, the recording unit 2 includes a body portion 4 that holds each mechanism, and a leg portion 5 that supports the body portion 4 at a predetermined position in the Z direction. The body portion 4 holds each mechanism within a substantially rectangular parallelepiped housing portion 41. An exterior of the housing portion 41 is provided with a discharge port 70 and an ink tank cover 80. The discharge port 70 includes an opening through which a sheet on which an image has been printed (recorded) is discharged, and a peripheral portion surrounding the opening.

Note that in the following embodiments, the surface of the housing portion 41 on which the discharge port 70 is provided is referred to as a “front surface of the housing portion 41,” and a surface opposite to the front surface is referred to as a “rear surface of the housing portion 41.” Furthermore, as viewed from the discharge port 70 side, surfaces connecting the front surface and the rear surface of the housing portion 41 are referred to as an upper surface, a lower surface, and lateral surfaces (or a right surface and a left surface) of the housing portion 41.

When the ink tank cover 80 is open, access to an ink tank is permitted, thereby allowing a user to replace the ink tank. In FIGS. 1A and 1B, the ink tank cover 80 is closed.

The operation display portion 160 includes an operation portion, such as buttons operated by a user to input instructions for setting conditions of the recording unit 2 or the reading unit 3, and a display portion that displays a setting screen. Note that the operation display portion 160 may include only one of the functions of the display portion and the operation portion.

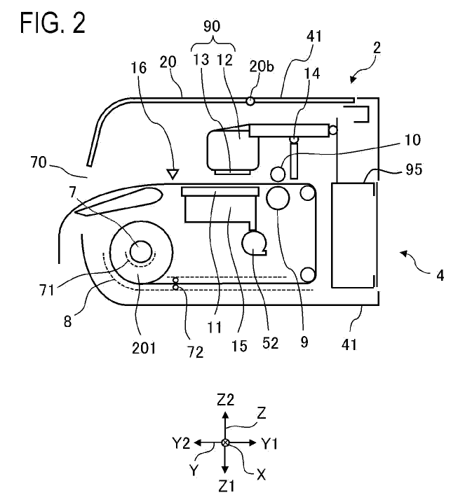

FIG. 2 is a schematic cross-sectional view illustrating a configuration of the recording unit 2 in the composite apparatus 1 according to this embodiment. The recording unit 2 is capable of printing an image on a sheet supplied from a rolled sheet 201 in which a sheet is wound into a roll.

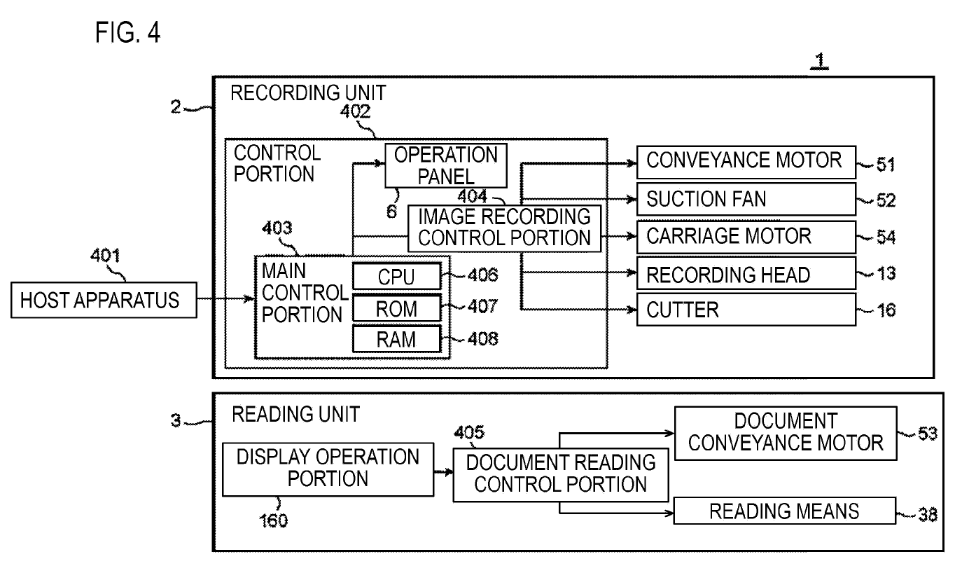

When printing an image on the rolled sheet 201, a user first attaches a roll holder 7 to a center hole of the rolled sheet 201 and causes the roll holder 7 to be rotatably held by a roll holding portion 71 provided in the recording unit 2. The roll holding portion 71 is positioned below a platen 11 and on the front side of the housing portion 41. The user causes, from the front side of the housing portion 41, the roll holding portion 71 to hold the rolled sheet 201 to which the roll holder 7 is attached. Thereafter, the user feeds the sheet drawn out from the rolled sheet 201 to a downstream side of a sheet feeding path (sheet conveyance path) along a lower guide 8. Here, when a leading end of the rolled sheet 201 reaches a pair of rollers 72, the pair of rollers 72 is rotated by a motor (not illustrated). As a result, the sheet is conveyed within the sheet feeding path. When the sheet reaches a nip portion between a conveyance roller 9 and a driven roller 10, the conveyance roller 9 is rotated by a drive force supplied from a conveyance motor 51 (see FIG. 4). As a result, the sheet is nipped between the conveyance roller 9 and the driven roller 10. Thereafter, the sheet is conveyed onto the platen 11 by rotation of the conveyance roller 9.

The platen 11 holds the sheet from its rear surface to keep the sheet flat and maintains a gap suitable for printing between a recording head 13 and the sheet. In order to prevent the sheet from floating and bending on the platen 11, the platen 11 is provided with a plurality of suction holes for sucking the sheet. The suction holes are in communication with a suction fan 52 through a duct 15. By driving the suction fan 52, a negative pressure is generated in the suction holes of the platen 11, and the sheet passing over the platen 11 moves on the platen 11 while being sucked through the suction holes.

A printing portion 90 serving as a recording portion includes a carriage 12 and the recording head 13 and performs printing (recording) on a sheet serving as a recording medium. The printing portion 90 is arranged above the roll holding portion 71. The carriage 12 reciprocates, upon receiving a drive force supplied from a carriage motor 54 (see FIG. 4), in the X direction (main scanning direction) along a carriage shaft 14. The recording head 13 is mounted on the carriage 12. In the recording head 13, a plurality of ejection ports for ejecting ink are arrayed along a direction intersecting the X direction (a direction (Y direction) orthogonal to the X direction in this embodiment). Note that in this embodiment, the recording head 13 constitutes a so-called serial printer that performs printing on a sheet while moving in the X direction, but the present disclosure is not limited thereto. For example, the recording head 13 may also be a line head.

While the recording head 13 moves in the X direction together with the carriage 12, ink is ejected from the ejection ports of the recording head 13 in accordance with recording data. As a result, an image (an image for one band) having a width corresponding to the number of the ejection ports arranged is printed on the sheet. After an image for one band is printed, the sheet is conveyed by a predetermined distance in the Y direction by rotation of the conveyance roller 9. Thereafter, movement of the carriage 12 and ejection of ink by the recording head 13 are performed again, thereby printing an image for the next band. By repeating the recording operation on the sheet and the conveyance operation of the sheet, a predetermined image (e.g., an image for one page) is printed on the sheet.

The discharge port 70 discharges the sheet on which printing has been performed by the recording head 13. The discharge port 70 is provided downstream of the recording head 13 in a sheet conveyance direction (Y direction). Furthermore, the discharge port 70 is preferably provided on the front side of the housing portion 41 at a position where the user can easily access.

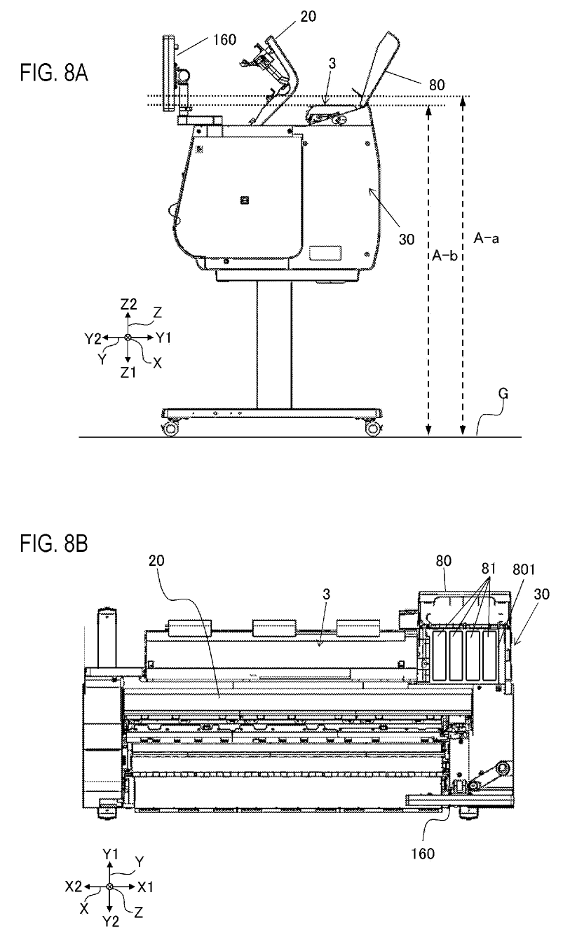

Ink (a liquid to be used for recording) is supplied via a tube from an ink tank (liquid container) storing the ink to the recording head 13. The ink tank unit 30 is arranged side by side with the reading unit 3 in a second direction intersecting both the conveyance direction in which a recording material and a document are conveyed and the vertical direction, and in a second direction intersecting a first direction in which the access cover 20 moves from a closed position to an open position, that is, in the X direction in this embodiment. The ink tank unit 30 includes an accommodation portion 801 having an insertion port opened upward and capable of accommodating an ink tank 81, and an ink tank cover 80 (accommodation portion cover) for opening and closing the insertion port (see FIGS. 8A and 8B). With the ink tank cover 80 opened, the ink tank 81 is configured to be attachable to and detachable from the accommodation portion 801 in the vertical direction. That is, when the ink tank cover 80 is opened, access to the ink tank 81 is permitted, thereby allowing the user to replace the ink tank 81. When the ink tank cover 80 is in an open position, the accommodation portion 801 of the ink tank 81 is opened upward (in the Z2 direction). By being inserted into or extracted from the accommodation portion 801 in the vertical direction (Z direction), the ink tank 81 becomes attachable to and detachable from the accommodation portion 801. A plurality of ink tanks 81 are configured to be attachable to the accommodation portion 801 in a manner aligned in the Y direction.

In the recording unit 2, a cutter 16 is provided downstream of the recording head 13 in the conveyance direction (Y direction) so that the sheet pulled out from the rolled sheet 201 can be cut to a predetermined length.

At an upper portion on the front side of the housing portion 41 of the recording unit 2, the opening and closing access cover 20 (opening and closing cover) for accessing the inside of the recording unit 2 is rotatably (movably) provided about a rotation shaft 20b having a rotation axis extending in the X direction. As illustrated in FIG. 2, the access cover 20, which forms a part of the housing portion 41, is rotatable between a closed position at which an upper portion of the recording head 13 (printing portion 90) is covered and an open position at which the recording head 13 is exposed to the outside.

In addition, on the rear side of the housing portion 41 of the recording unit 2, a substrate accommodation member 95 for accommodating a power supply and a control circuit for controlling each mechanism is provided. The substrate accommodation member 95 is a sheet-metal member having an internal space and a substantially square cross section, and is a substantially rectangular parallelepiped member extending in the X direction of the recording unit 2.

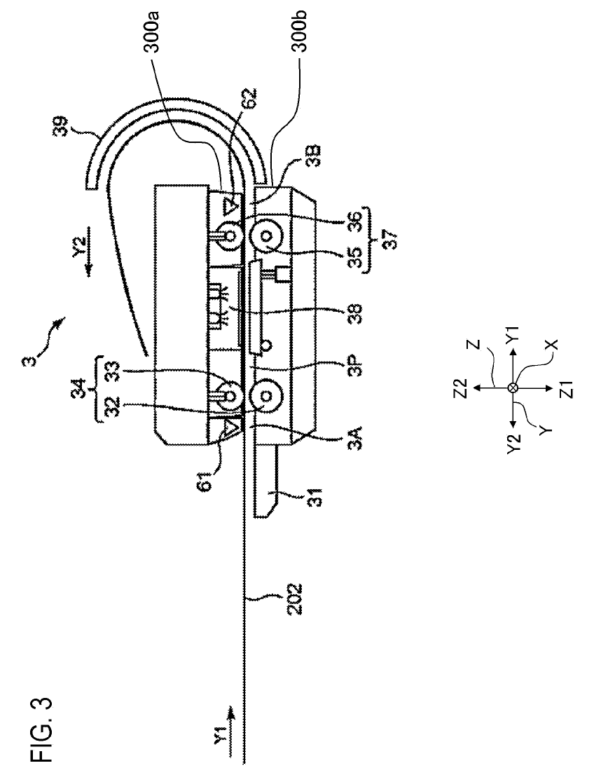

FIG. 3 is a schematic cross-sectional view illustrating a configuration of the reading unit 3 in the composite apparatus 1 according to this embodiment. The reading unit 3 reads an image by the reading means 38 while conveying a document 202. The reading unit 3 is provided with a conveyance path 3P that extends from an insertion port 3A through which the document 202 is inserted to a discharge port 3B through which the document is discharged. The document inserted through the insertion port 3A is conveyed along the conveyance path 3P. The reading unit 3 is provided with a flat-plate document setting portion 31 that protrudes forward (leftward in FIG. 3) from a lower edge portion of the insertion port 3A. The document setting portion 31 has substantially the same width (length in the X direction) as that of the insertion port 3A, holds the document from a non-reading side opposite to a reading side of the document, and guides the insertion of the document into the insertion port 3A. Furthermore, the reading unit 3 is provided, on the rear side (right side in FIG. 3), with a curved document discharge portion 39 that guides the document discharged through the document discharge port onto an upper surface of the reading unit 3. Upstream-side conveyance means 34 is provided upstream of the conveyance path 3P, and downstream-side conveyance means 37 is provided downstream of the conveyance path 3P. The document is conveyed along the conveyance path 3P by the upstream-side conveyance means 34 and the downstream-side conveyance means 37. The upstream-side conveyance means 34 is composed of an upstream-side conveyance roller 32 and an upstream-side driven roller 33 that is provided facing the upstream-side conveyance roller 32. The downstream-side conveyance means 37 is composed of a downstream-side conveyance roller 35 and a downstream-side driven roller 36 that is provided facing the downstream-side conveyance roller 35.

The reading unit 3 includes a first portion 300a that faces a surface to be read of the document 202, and a second portion 300b that faces a surface (rear surface) opposite to the surface to be read of the document 202. The first portion 300a is positioned above the insertion port 3A, and the second portion 300b is positioned below the insertion port 3A. The first portion 300a and the second portion 300b are arranged facing each other across the document 202, and the conveyance path 3P is formed therebetween. The document 202 is conveyed on the conveyance path 3P between the first portion 300a and the second portion 300b, and an image or the like on the surface to be read is read by reading means 38 serving as a reading portion provided in the first portion 300a. The reading means 38 for reading the document 202 is provided between the upstream-side conveyance means 34 and the downstream-side conveyance means 37. The reading means 38 is composed of a contact image sensor (CIS) having light receiving elements arrayed in a width corresponding to a width of a large document to be used. However, it is also possible to use another linear sensor using a CCD or the like.

When reading the document by the reading unit 3, the user places a front portion of the document 202 on the document setting portion 31 and then inserts the document 202 into the insertion port 3A along a guide surface (upper surface) 31a of the document setting portion 31. When a leading end of the document 202 is inserted into the conveyance path 3P through the insertion port 3A, an upstream document sensor 61 provided in the vicinity of the insertion port 3A detects the insertion of the document 202 into the insertion port 3A. When the leading end of the document 202 reaches a nip portion of the upstream-side conveyance means 34 composed of the upstream-side conveyance roller 32 and the upstream-side driven roller 33, the upstream-side conveyance roller 32 is rotated in a forward direction by a document conveyance motor 53 illustrated in FIG. 4. As a result, the document 202 enters between the upstream-side conveyance roller 32 and the upstream-side driven roller 33 and is nipped therebetween.

Note that in this embodiment, a delay time is provided between when the upstream document sensor 61 detects the leading end of the document 202 and when the upstream-side conveyance roller 32 is driven to rotate. This delay time corresponds to a waiting time until the entire width of the leading end of the document 202 abuts against the nip portion of the upstream-side conveyance means 34. By rotating the upstream-side conveyance roller 32 in a state in which the entire leading end of the document 202 is abutted against the nip portion, it is possible to suppress conveyance of the document 202 in a state in which the leading end of the document 202 is inclined relative to the upstream-side conveyance roller 32. The delay time is suitably about 0.5 to 2 seconds. However, an optimum value of the delay time varies depending on a distance between the upstream document sensor 61 and the upstream-side conveyance means 34.

When the upstream-side conveyance roller 32 is driven to rotate, the document 202 is conveyed to the reading means 38. Thereafter, the document 202 is nipped between the downstream-side conveyance roller 35 and the downstream-side driven roller 36, which are rotated in the forward direction by the document conveyance motor 53 in the same manner as the upstream-side conveyance roller 32, and is conveyed until a downstream document sensor 62 detects the document 202. During that time, the reading means 38 performs, as a pre-detection operation, a reading operation on the document 202 passing through the reading area of the reading means 38. As a result of this reading operation, information relating to the width and inclination of the document 202 is acquired. Upon completion of the pre-detection operation, the upstream-side conveyance roller 32 and the downstream-side conveyance roller 35 are rotated in the backward direction by the document conveyance motor 53 to return the document 202 to the upstream side, thereby placing the document 202 in a standby state. Note that in this document returning operation, control is performed such that the leading end of the document 202 in the standby state is positioned downstream of the nip portion of the upstream-side conveyance means 34 and upstream of the reading area of the reading means 38 in the conveyance direction (Y1 direction).

After the pre-detection operation, when an instruction to start a reading operation is input through the operation display portion 160 or the like, the document 202 is conveyed in the document conveyance direction Y1 by the upstream-side conveyance means 34 and the downstream-side conveyance means 37 while the reading means 38 performs a reading operation on the document 202. When the upstream document sensor 61 detects a rear end of the document 202, the rear end of the document 202 is conveyed to a position downstream of the reading area of the reading means 38 and upstream of the nip portion of the downstream-side conveyance means 37 in the conveyance direction (Y1 direction). In this state, the document reading operation is completed. Thereafter, when an instruction to start a discharge operation is input through the operation display portion 160 or the like, the document 202 is conveyed again by the downstream-side conveyance means 37 and is released from the nip of the downstream-side conveyance means 37. As a result, the document 202 can be removed.

Note that the document 202 that has passed through the document discharge portion 39 is conveyed in a conveyance direction Y2 opposite to the conveyance direction (Y1 direction) and is discharged onto an upper surface of the reading unit 3. This enables the user to perform both insertion of the document 202 into the insertion port 3A and removal of the read document 202 from the same direction (front side), thereby providing excellent operability. In this embodiment, after completion of the reading operation, the conveyance operation of the document 202 is temporarily stopped while the document 202 is nipped by the downstream-side conveyance means 37. However, after the completion of the reading operation, the conveyance operation of the document 202 may instead be continued until the document 202 is released from the nip of the downstream-side conveyance means 37.

FIG. 4 is a block diagram illustrating the hardware configuration of the composite apparatus 1. A schematic configuration of the control system according to this embodiment will be described with reference to the block diagram illustrated in FIG. 4. A host apparatus 401 is connected to the composite apparatus 1, and recording data and various control commands generated by the host apparatus 401 are transmitted to a control portion 402. The control portion 402 mainly includes a main control portion 403 and an image recording control portion 404. The main control portion 403 includes a CPU 406, a ROM 407, and a RAM 408. The CPU 406 performs various arithmetic operations in accordance with various programs and parameters stored in the ROM 407 while using the RAM 408 as a work area, and performs overall control of the composite apparatus 1. The image recording control portion 404 controls a conveyance motor 51, a suction fan 52, a carriage motor 54, the recording head 13, the cutter 16, and the like on the basis of instructions from the main control portion 403. An document reading control portion 405 controls the document conveyance motor 53, the reading means 38, and the like on the basis of input to the operation display portion 160, which serves as a large operation panel.

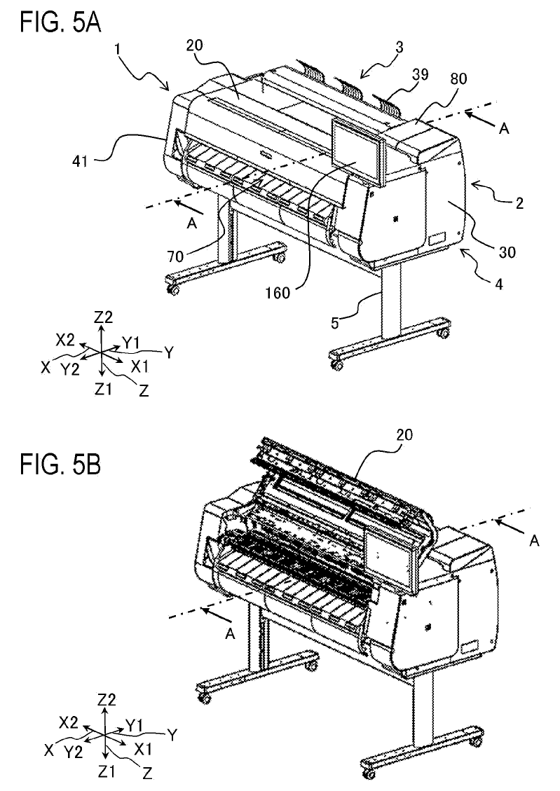

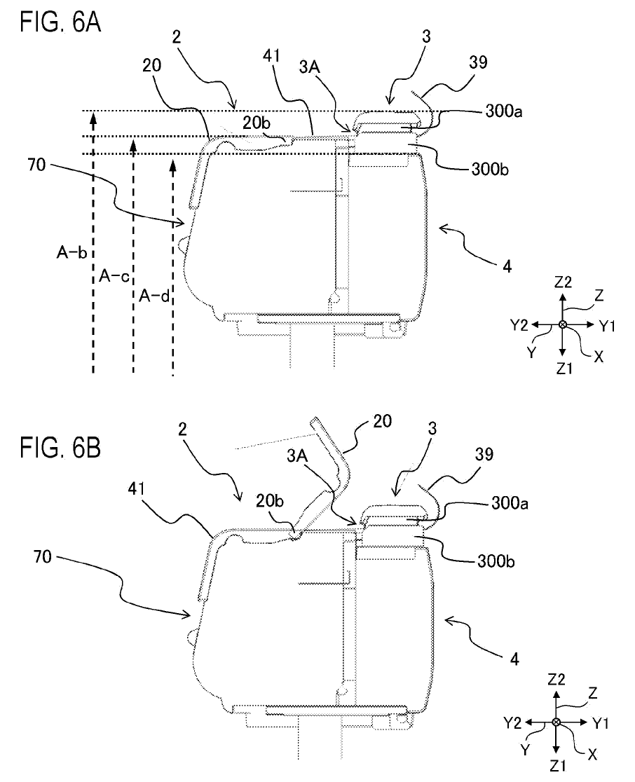

The arrangement of the reading unit 3, which is a characteristic of this embodiment, will be described with reference to , FIGS. 1A and 1B, 5A and 5B and 6A and 6B. FIG. 5A is a perspective view of the composite apparatus 1 with the access cover 20 closed. FIG. 5B is a perspective view of the composite apparatus 1 with the access cover 20 open. FIG. 6A is a cross-sectional view taken along line A-A in FIGS. 5A and 6B is a cross-sectional view taken along line A-A in FIG. 5B.

In this embodiment, the access cover 20 is the outermost cover of the apparatus that, when opened, enables access to the interior of the recording unit 2, and does not include an inner cover or the like.

Here, in FIGS. 1A and 6A, the relationships between the widths (in the X direction) and the heights (in the Z direction) of the recording unit 2, the reading unit 3, the access cover 20, and the ink tank unit 30 are indicated by symbols. In FIG. 1A, A-b indicates the height of the reading unit 3 (the highest portion, specifically, the upper surface of the first portion 300a) from the installation surface of the composite apparatus 1, excluding the document discharge portion 39. Furthermore, in FIG. 1A, A-c indicates the height of the access cover 20 (the upper surface of the access cover 20) from the installation surface of the composite apparatus 1. Furthermore, in FIG. 1A, A-a indicates the height of the ink tank unit 30 (the upper surface of the ink tank cover 80) from the installation surface of the composite apparatus 1. In FIG. 6A, A-d indicates the height of the lower end (lower surface) of the second portion 300b of the reading unit 3 from the installation surface of the composite apparatus 1. In FIG. 1B, B-b indicates the width of the reading unit 3, B-c indicates the width of the access cover 20, B-a indicates the width of the recording unit 2, and B-d indicates the width of the ink tank unit 30.

The reading unit 3 is arranged outside an opening/closing locus of the access cover 20 and in a space on the rear side in the opening direction of the access cover 20. This space is an empty space (dead space) created by a rearward protrusion of the ink tank unit 30 when the ink tank unit 30 is arranged rearward. Accordingly, at least a part of the reading unit 3 can be arranged at a position lower than the upper surface of the access cover 20. More specifically, substantially most of the second portion 300b of the reading unit 3 can be arranged at a position recessed relative to the upper surface of the access cover 20. As a result, as illustrated in FIG. 6A, when the access cover 20 is closed, the height of the uppermost surface (A-c) of the access cover 20 can be aligned with the height of the insertion port 3A of the reading unit 3 for the document 202. Therefore, the upper surface of the access cover 20 can be used as a guide for the document 202. As a result, although the reading unit 3 is arranged further rearward relative to a front side of the apparatus compared with a conventional configuration, front operability for document reading can be improved.

Moreover, the access cover 20 is configured to be opened not from the rear side toward the front side but from the front side toward the rear side of the apparatus, that is, from the front side to the rear side of the apparatus (first direction). Since this configuration does not obstruct front operability when the access cover 20 is opened, operability is improved.

In this embodiment, the reading unit 3 is arranged further toward the rear side than the access cover 20 in the first direction in which the access cover 20 moves from the closed position to the open position. The reading unit 3 is fixed at a position offset from a movement locus of the access cover 20 that moves between the closed position and the open position. Furthermore, the reading unit 3 is positioned further toward the rear side than the recording unit 2 in the first direction in which the access cover 20 moves from the closed position to the open position. In addition, the reading unit 3 includes a portion arranged at a position lower than the upper surface of the access cover 20 when the access cover 20 is in the closed position. More specifically, in the reading unit 3, at least a part of the second portion 300b, which is arranged at a position lower than the insertion port 3A for the document 202 that is opened in the direction opposite to the first direction, overlaps the access cover 20 in the closed position as viewed in the first direction. With this configuration, the upper surface of the access cover 20 in the closed position can support the document 202 inserted into the insertion port 3A.

In this manner, by arranging the reading unit 3 at a position offset from an opening/closing locus of the access cover 20 and on the rear side in the opening direction of the access cover 20, the operation of the access cover 20 and the reading operability of the reading unit 3 can be improved without providing a large and complicated retracting mechanism for the reading unit 3, as in conventional configurations.

### Second Embodiment

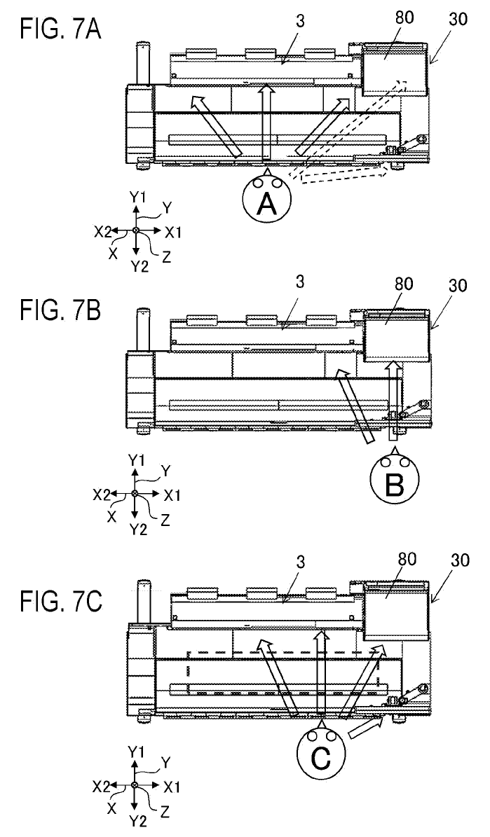

A second embodiment of the present disclosure will be described with reference to FIGS. 7A-7C. In the second embodiment, components that are the same as those in the first embodiment are denoted by the same reference numerals, and duplicated descriptions thereof are omitted. Matters not specifically described in the second embodiment are the same as those in the first embodiment.

FIGS. 7A-7C are top views, in which A, B, C indicate positions where a user stands to operate the apparatus, arrows indicate the ranges within which the user’s hand can reach, and broken arrows indicate areas that the user’s hand cannot reach.

At the position A illustrated in FIG. 7A, the user can perform a document reading operation on the reading unit 3, but cannot perform an ink tank operation (including an operation for the ink tank cover 80) and operate the operation display portion 160, which serves as a large operation panel and will be described later, because the user’s hand cannot reach those areas. At the position B illustrated in FIG. 7B, the user can perform an ink tank operation and operate the operation display portion 160, but cannot operate the reading unit 3. That is, when performing a document reading operation, an ink tank operation, and an operation on the operation display portion 160 in succession, the user is required to move back and forth between the positions A and B, which is cumbersome. If possible, the user desires to perform all operations at a single spot. Therefore, by standing at the position C illustrated in FIG. 7C, which is a substantially intermediate position between the positions A and B, the user can perform reading operations for documents of most sizes (excluding extremely wide documents), as well as ink tank operations, and operations on the operation display portion 160 without changing positions, thereby improving overall operability.

However, at the position C, in an conventional example, the reading unit 3 obstructs the opening and closing operation of the ink tank cover 80. Broken lines in FIG. 7C indicate the position of the reading unit 3 in the conventional example, and a right arrow indicates an ink tank operation that is obstructed by the reading unit 3. In this embodiment, since the reading unit 3 is arranged next to the ink tank unit 30 at a position that does not overlap the ink tank unit 30 in the longitudinal direction of the reading unit 3 (B-b and B-d in FIG. 1B do not overlap), the reading unit 3 does not obstruct the operation at the position C.

Furthermore, in the height direction, the reading unit 3 is arranged such that it slightly overlaps the ink tank unit 30, thereby preventing the reading unit 3 from being positioned high. The ink tank cover 80 is provided to be openable and closable at the top of the ink tank unit 30, and is arranged such that the reading unit 3 overlaps the ink tank cover 80 when the ink tank cover 80 is closed, thereby preventing the reading unit 3 from being positioned excessively high.

FIGS. 8A and 8B are side views illustrating a state in which the access cover 20 and the ink tank cover 80 are open. The reading unit 3 is positioned lower than the uppermost surfaces of the access cover 20 and the ink tank cover 80 in the open state, and also positioned lower than the uppermost portion of the operation display portion 160. That is, the highest portion of the reading unit 3, including the document discharge portion 39, is positioned lower than the highest portion of the access cover 20 in the open position. Similarly, the highest portion of the reading unit 3, including the document discharge portion 39, is positioned lower than the highest portion of the ink tank cover 80 in the open position. Similarly, the highest portion of the reading unit 3, including the document discharge portion 39, is positioned lower than the highest portion of the operation display portion 160.

As described above, the reading unit 3 is arranged next to the ink tank unit 30 at a position that does not overlap the ink tank unit 30 in the longitudinal direction of the reading unit 3 (B-b does not overlap B-d in FIG. 1B), and at the same time at a position where it at least partially overlaps the ink tank unit 30, with the ink tank cover 80 closed, in the height direction of the reading unit 3 (In FIG. 1A, A-b partially overlaps A-a since A-b is positioned lower than A-a). With this configuration, operability at the position C can also be improved.

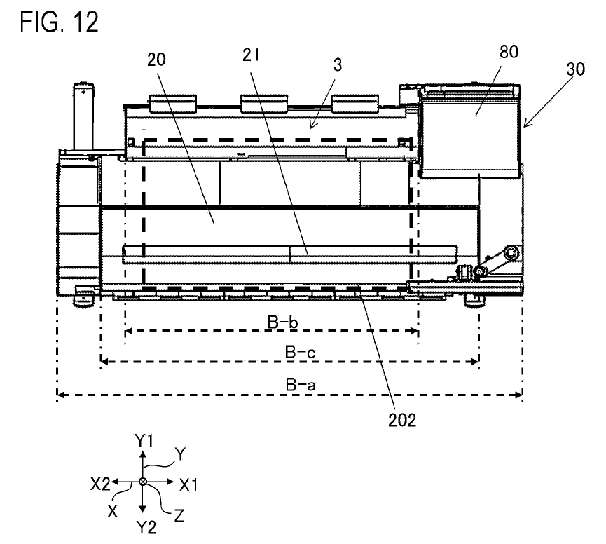

Furthermore, as illustrated in FIG. 12 (top view), the upper surface of the access cover 20 is provided with a transparent window 21 serving as a window portion into which a transparent member is fitted, such that the inside of the access cover 20 is visible from the outside. Since the interior of the apparatus can be visually recognized through the transparent window 21, the interior can be confirmed without opening the access cover 20. The transparent member fitted into the transparent window 21 is made of a light-transmitting material, such as a light-transmitting resin (for example, a transparent acrylic resin), glass, or the like, and the degree of transparency (translucency) may be such that an internal state of the access cover 20 can be visually recognized. In particular, since the access cover 20 is locked during printing, it is convenient to be able to confirm the printing state and printed images without opening the access cover 20.

Meanwhile, the document 202 read by the reading unit 3 is discharged onto the access cover 20 and hides the transparent window 21 as illustrated in FIG. 12 (broken lines in FIG. 12 indicate the document 202). Even in this case, an end (right side) of the transparent window 21 is arranged further outward (right side) than an end (right side) of the reading unit 3, thereby preventing the document 202 from completely hiding the transparent window 21.

As described above, by arranging at least one end of the transparent window 21 of the access cover 20 further outward than an end of the reading unit 3, the interior of the apparatus can be visually confirmed through the transparent window 21 without being hidden by the discharged document 202.

### Third Embodiment

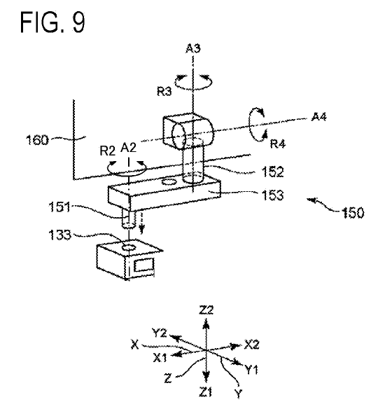

A third embodiment of the present disclosure will be described with reference to FIGS. 9, 10A, 10B and 11. The third embodiment is characterized in that visibility is improved by the arrangement of the operation display portion 160. In the third embodiment, components that are the same as those in the first and second embodiments are denoted by the same reference numerals, and duplicated descriptions thereof are omitted. Matters not specifically described in the third embodiment are the same as those in the first and second embodiments.

First, an ink tank operation will be described. When an front operation is performed on the ink tank unit 30 arranged rearward, the operation display portion 160 obstructs the operation. Therefore, the operation display portion 160 is provided with a mechanism that allows its posture to be changed so as not to obstruct the operation. By changing its posture, the operation display portion 160 can be retracted from a locus of the front operation on the ink tank unit 30. Similarly, when an opening and closing operation of the access cover 20 is performed, the operation display portion 160 obstructs the operation. Therefore, the operation display portion 160 is retracted by the posture change mechanism. The operation will be described below.

FIG. 9 is a schematic view of a monitor holding portion 150 serving as the posture change mechanism of the operation display portion 160, which will be described later. In FIG. 9, the operation display portion 160 is held by the monitor holding portion 150. The monitor holding portion 150 is a support portion that supports the operation display portion 160 serving as an operation portion in such a manner that the posture of the operation display portion 160 can be changed. The monitor holding portion 150 can change the posture of the operation display portion 160 by rotating the operation display portion 160 about a rotation axis that extends along a vertical direction intersecting the first direction in which the access cover 20 moves from the closed position to the open position. The rotation axis about which the orientation of the operation display portion 160 is changed may be a single rotation axis or a plurality of rotation axes. The monitor holding portion 150 can support the operation display portion 160 in a posture in which a monitor (a display surface or an operation surface) on the front side of the operation display portion 160 is oriented in a direction opposite to the first direction, that is, toward the front side of the apparatus.

Specifically, the monitor holding portion 150 has a rotation axis A2 and is configured to rotatably hold the operation display portion 160 in a direction R2. The operation display portion 160 is mounted on the monitor holding portion 150. The operation display portion 160 has a rotation axis A3 and a rotation axis A4 with respect to the monitor holding portion 150 and is rotatably held in directions R3 and R4.

The monitor holding portion 150 includes a rotation shaft portion 151, a monitor connecting portion 152, and an arm portion 153. The rotation shaft portion 151 is connected to a relay member 130 and the arm portion 153. The arm portion 153 is a member extending in the X direction and having a substantially rectangular parallelepiped shape. The monitor connecting portion 152 is connected to the operation display portion 160 and the arm portion 153. The monitor connecting portion 152 is rotatable about the rotation axes A3 and A4 in the directions R3 and R4.

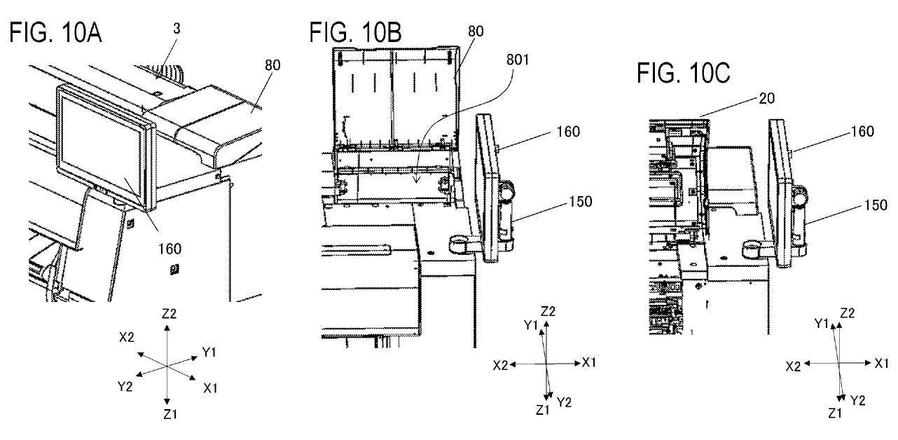

Next, the arrangement of the operation display portion 160 will be described. FIG. 9 is a perspective view illustrating the vicinity of the operation display portion 160 in the composite apparatus 1 and illustrates a position at which a user operates the operation display portion 160. FIG. 10A is a view illustrating a reference position of the operation display portion 160, and FIGS. 10B and 10C are views illustrating a position at which the operation display portion 160 is retracted so as not to interfere with operations of the ink tank and the access cover 20, which will be described later.

The operation display portion 160 is mounted on the monitor holding portion 150 via the monitor connecting portion 152. As described above, the monitor connecting portion 152 is rotatably held in the direction indicated by arrow R3. Furthermore, the monitor holding portion 150 is rotatably held by the relay member 130. For this reason, a user can move and operate the operation display portion 160 at a position and an angle that allow the user to easily operate the operation display portion 160 from the front side of the recording unit 2. On the other hand, with the arrangement of the operation display portion 160 illustrated in FIG. 10A, the user has difficulty accessing the ink tank cover 80 and the access cover 20 from the front side of the recording unit 2.

In FIGS. 10B and 10C, the recording unit 2 is in a state in which the ink tank cover 80 is open and access to the ink tank 81 is possible. As illustrated in FIG. 10B, the rotation shaft portion 151 of the monitor holding portion 150 is movable to a position further outward (on the X1 side) than the front surface of the ink tank cover 80. Accordingly, by moving the operation display portion 160, the user can access the ink tank from the front side of the recording unit 2.

Next, an improvement in visibility of the operation display portion 160 will be described.

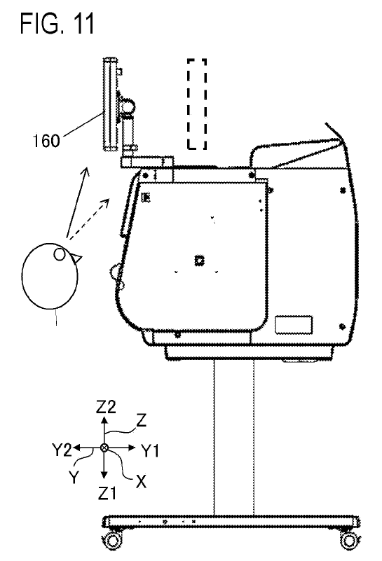

As illustrated in FIG. 11, in the present disclosure, the rotation shaft portion 151 of the monitor holding portion 150 is provided on the foremost side of the body, and the posture of the operation display portion 160 is changeable such that a monitor (a display surface or an operation surface) serving as the front surface of the operation display portion 160 can be arranged further forward than the recording unit 2. As a result, unlike a conventional apparatus (indicated by broken lines in FIG. 11), even when the user is in a low position in front of the body (a position A in FIG. 11), the operation display portion 160 can be viewed without being obstructed by the body, thereby improving visibility. In this manner, for example, during a rolled sheet replacement operation or the like (not illustrated), the user can perform the operation while confirming the operation display portion 160 even in a squatting posture, thereby improving operability.

As described above, in the operation display portion 160 including the monitor holding portion 150 having a retracting mechanism, the monitor (a display surface or an operation surface) serving as a front surface of the operation display portion 160 is arranged further forward than the recording unit 2, thereby enabling an improvement in visibility of the operation display portion 160.

According to the present disclosure, it is possible to improve operability of the apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-074536, filed Apr. 28, 2025, which is hereby incorporated by reference herein in its entirety.

What is claimed is:

1. A recording apparatus comprising:
a holding portion configured to be capable of holding a rolled sheet in which a sheet is wound into a roll;
a recording portion configured to perform, above the holding portion, recording on a sheet supplied from the rolled sheet held by the holding portion;
a housing configured to accommodate the recording portion;
a cover configured to be movable between an open position at which the recording portion is exposed to an outside from a front side of the housing and a closed position at which the recording portion is closed relative to the open position; and
a reading unit configured to perform reading of a document, wherein a direction in which the cover moves from the closed position toward the open position is a first direction from the front side toward a rear side of the housing, and the reading unit is arranged further toward the rear side than the cover in the first direction.

2. The recording apparatus according to claim 1, wherein
the reading unit is fixed at a position offset from a movement locus of the cover that moves between the closed position and the open position.

3. The recording apparatus according to claim 1, wherein
the recording portion is a recording head configured to eject a liquid onto the sheet.

4. The recording apparatus according to claim 1, wherein
the reading unit includes a portion arranged at a position lower than an upper surface of the cover in the closed position.

5. The recording apparatus according to claim 4, wherein
the reading unit includes an insertion port for the document, the insertion port being opened in a direction opposite to the first direction, and
the upper surface of the cover in the closed position is configured to be capable of supporting the document inserted into the insertion port.

6. The recording apparatus according to claim 5, wherein
the cover is provided with a window portion into which a transparent member is fitted, such that an inside of the cover in the closed position is visible from the outside, and
the window portion includes a portion that is not hidden by the document supported on the upper surface of the cover in the closed position.

7. The recording apparatus according to claim 5, wherein
the reading unit includes a first portion positioned above the insertion port and a second portion positioned below the insertion port, and
at least a part of the second portion overlaps the cover in the closed position as viewed in the first direction.

8. The recording apparatus according to claim 1, wherein
a highest portion of the reading unit is positioned lower than a highest portion of the cover in the open position.

9. The recording apparatus according to claim 3, further comprising:
a liquid supply unit in which a liquid container configured to accommodate a liquid to be used in the recording portion is attachably and detachably held, wherein
the liquid supply unit is arranged side by side with the reading unit in a second direction intersecting both a conveyance direction in which a recording material and a document are conveyed and a vertical direction, the second direction intersecting the first direction.

10. The recording apparatus according to claim 9, wherein
the liquid supply unit includes an accommodation portion having an insertion port opened upward and capable of accommodating the liquid container, and an accommodation portion cover for opening and closing the insertion port, wherein the liquid container is configured to be attachable to and detachable from the accommodation portion in a vertical direction as the accommodation portion cover is opened, and wherein
a highest portion of the reading unit is positioned lower than a highest portion of the accommodation portion cover in the closed position.

11. The recording apparatus according to claim 9, further comprising:
an operation portion operated by a user; and
a support portion configured to support the operation portion in such a manner that a posture of the operation portion is changeable, wherein the support portion supports the operation portion at a position further toward the front side than the reading unit in the first direction.

12. The recording apparatus according to claim 1, further comprising:
an operation portion operated by a user; and
a support portion configured to support the operation portion in such a manner that a posture of the operation portion is changeable, wherein the support portion supports the operation portion at a position further toward the front side than the reading unit in the first direction.

13. The recording apparatus according to claim 12, wherein
the support portion is capable of supporting the operation portion in a posture in which an operation surface of the operation portion is oriented in a direction opposite to the first direction.

14. The recording apparatus according to claim 13, wherein
the support portion changes a posture of the operation portion by rotating the operation portion about a rotation axis that extends along a direction intersecting the first direction.

15. The recording apparatus according to claim 12, wherein
a highest portion of the reading unit is positioned lower than a highest portion of the operation portion.
